(19) United States
(12) Patent Application Publication
(10) Pub. No.: US 2017/0314144 A1
(43) Pub. Date: Nov. 2, 2017

(54) Seawater Electrolysis Hydrogen Recovery And Power Generation System

(71) Applicant: Chun-Yi Yu, Taoyuan City (TW)

(72) Inventor: Chun-Yi Yu, Taoyuan City (TW)

(21) Appl. No.: 15/262,914

(22) Filed: Sep. 12, 2016

(30) Foreign Application Priority Data
Apr. 29, 2016 (TW) 105113626

(51) Int. Cl. C25B 1/04; F17D 1/08; F17D 1/04; F01D 15/10; F01D 15/08; F01D 9/02; F01D 5/02; F17D 1/14; C25B 1/26

(52) U.S. Cl. CPC C25B 1/04; F17D 1/14; F17D 1/08; F17D 1/04; C25B 1/26; F01D 15/08; F01D 9/02; F01D 5/02; F01D 15/10

(57) ABSTRACT

A seawater electrolysis hydrogen recovery and power generation system is capable of recovering hydrogen gas and using the hydrogen gas to drive an electric turbine generator during the operation of a seawater electrolyzer for production of sodium hypochlorite. The seawater electrolysis hydrogen recovery and power generation system includes pipelines, booster pumps, a plenum chamber and a condenser chamber.

### CROSS REFERENCE TO RELATED PATENT APPLICATIONS

The present disclosure claims the priority benefit of Taiwan Patent Application No. 105113626, filed on 29 Apr. 2016, which is incorporated by reference in its entirety.

### TECHNICAL FIELD

The present disclosure is generally related to seawater electrolysis and, more particularly, to seawater electrolysis with hydrogen recovery and electric power generation.

### BACKGROUND

Unless otherwise indicated herein, approaches described in this section are not prior art to the claims listed below and are not admitted to be prior art by inclusion in this section.

The so-called electrolysis refers to applying an electric current through an electrolyte solution or molten material such that an oxidation-reduction reaction occurs at a cathode and an anode. When a voltage is applied to an electrochemical cell (i.e., charging), the process of electrolysis occurs. All ionic compounds are electrolytes, as ions can move freely under applies voltage to conduct currents when they are dissolved in the liquid of the solution. Examples of the electrolysis of water are shown below.

2H₂O→O₂+4H⁺+4e⁻ Anode:

2H₂O+2e⁻→H₂+2OH⁻ Cathode:

2H₂O→2H₂+O₂ Total reaction formula:

In this reaction, the anode releases electrons (oxidation), and the cathode obtains electrons (reduction).

Power plants typically use circulating pump to pump seawater into water channels, which go through a furnace room, a steam room and so on to dissipate the waste heat generated by such power generation equipment to an aeration tank and to discharge the heat into the air. Then, the seawater is released into the ocean. To avoid growth of marine deposits, which tends to cause pipe blockage, which would reduce the cooling effect, and even corrosion of pipeline that affects the efficiency of power generation and equipment lifetime, chlorine is a necessary additive to the water channels to suppress the undesired growth of marine deposits.

There are generally two methods of adding chlorine into seawater to suppress the growth of marine deposits, including a chlorine method and a sodium hypochlorite method. Due to higher costs associated with the transportation and storage management of chlorine, the chlorine method is less desirable. Thus, the system using safer, low cost, automated manufacturing way by seawater electrolysis to produce sodium hypochlorite is the preferred solution.

The water electrolysis apparatus is one of the main equipment of power generating plants. Its manufacturing, installation, operation and maintenance have profound influence on the normal operation of the power plant unit.

Since the average salinity of seawater is about 35 parts per one thousand, salinity is the number of grams of salt per one thousand seawater, which is generally one kilogram of seawater contains 35 grams of salt. When the seawater is electrolyzed, the main chemical reactions are as follows:

Cathode: 2Cl→Cl₂⁺+2e⁻

Cl₂ Cathode product:

2H₂O+2e⁻→2OH⁻+H₂ Negative electrode:

2Na⁺+2OH⁻→2NaOH

2NaOH+H₂ The negative electrode product:

Chemical reaction, while electrolysis Cl₂ and NaOH:

2Cl₂+2NaOH→NaOCl+NaCl+H₂O

Here, NaOCl is sodium hypochlorite, used in a thermal power plant to inhibit the growth of marine deposits in the channel.

It is known that the water electrolysis apparatus can be divided into a total of six systems, namely: (1) seawater pressurization system, (2) the water filtration system, (3) seawater electrolysis system, (4) the hydrogen release system (5) sodium hypochlorite storage and injection system, and (6) acid-washing system

The principle of seawater electrolysis takes advantage of a seawater booster pump) to circulate water into the filtration system. First through the water filter (e.g., auto/manual strainer) seawater is filtered to remove larger than 0.5 mm of the impurities and marine life, etc., and then the seawater is pumped electrolysis system (electrolyzer) to produce sodium hypochlorite and hydrogen. Because the hydrogen gas is flammable and dangerous, it is important that hydrogen is separated by going through the hydrogen release system (hydrocyclone and hydrogen seal pot). The principle of centrifugal force is utilized to separate hydrogen from seawater. After hydrogen goes through the seal pot, it is slowly released into the atmosphere, while the water containing sodium hypochlorite is discharged into a storage tank. When the sodium hypochlorite storage tank reaches a predetermined level of height, the dosing system pumps seawater into a designated location. In addition, the seawater electrolysis system also results in the unwanted precipitate (MgOH₂ or CaCO₃), which will lead to lower efficiency of the electrode plate. A pickling system (acid clean system) is used by injection of 6% hydrochloric acid HCl to dissolve the precipitate in order to maintain normal operation of the system.

In a conventional seawater electrolysis system as shown in FIG. 1, the filtered seawater goes into the water electrolyzer via a transformer/rectifier set (T/R set), which provides current to the chemical reaction to produce sodium hypochlorite and hydrogen. An alternating arrangement of positive and negative plates increases the contact area with the water to improve the efficiency of the chemical reaction, as shown in FIG. 1. Furthermore, an increase in the positive and negative current can produce more sodium hypochlorite, as shown in FIG. 2.

Before sodium hypochlorite and seawater, generated by electrolysis of seawater, stream into the reservoir, the associated hydrogen needs to be separated from the water. This is because hydrogen is flammable gas, and at the concentration of 4% to 78%, hydrogen is easy to explode by spark. Therefore, a sodium hypochlorite storage tank, which is air tight, is used. To avoid possible accidents of explosion due to high pressure of hydrogen in the storage tank, the use of gas-water separator hydrocyclone by centrifugal force is vital to industrial safety. After separation, the hydrogen gas flows into hydrogen seal pot. Part of hydrogen will be dissolved into the water and part of it is discharged outside Seal Pot into the atmosphere.

In addition to the general use of hydrocyclone and seal pot in power plants for dehydrogenation, an open storage tank is also used to let the hydrogen naturally escape, with a fan to accelerate hydrogen discharge to the atmosphere. It is known that open sodium hypochlorite storage tanks are used, so that the hydrogen gas can easily escape into the atmosphere.

### SUMMARY

The following summary is illustrative only and is not intended to be limiting in any way. That is, the following summary is provided to introduce concepts, highlights, benefits and advantages of the novel and non-obvious techniques described herein. Select, and not all implementations, are further described below in the detailed description. Thus, the following summary is not intended to identify essential features of the claimed subject matter, nor is it intended for use in determining the scope of the claimed subject matter.

Apparent from the foregoing narrative, in order for power plants to provide the required sodium hypochlorite, the water electrolysis apparatus needs to be built. In the process of obtaining sodium hypochlorite, the hydrogen produced by electrolysis and seal pot hydrocyclone dehydrogenation, would escape into the atmosphere via open the hydrogen tank. However, other than that hydrogen is a clean energy, hydrogen should not be allowed to spill over into the atmosphere as it will damage the ozone layer. At present time hydrogen fuel cell powered vehicles are being sold in one or more countries, and therefore hydrogen emissions into the atmosphere is not only obviously a waste of energy, but also not conducive to environmental protection of the Earth. The present disclosure aims to solve this problem and to provide a viable technical solution.

In view of the above, the present disclosure proposes to first enhance water pressure by booster pump to pump seawater into the filtration system and then into the electrolysis unit to produce hydrogen with seawater containing sodium hypochlorite (hereinafter referred to as the -chlorine-and-hydrogen-containing seawater). In order to recover hydrogen from chlorine-and-hydrogen-containing seawater, the present disclosure discloses a seawater electrolysis hydrogen recovery and power generation system. The system includes: a first conduit having one end connected to the output of seawater electrolysis and the other end extending downwardly into the sea; a first booster pump, located in the first pipeline, pushing the output of the seawater electrolysis apparatus (i.e., chlorine-and-hydrogen-containing seawater) into the sea; a second pipeline, having a soft wall and with the left end of the pipeline connected to the lower end of the first pipeline; a third pipeline, with one end connected to the bottom right of the second pipeline and the other end of it rises to the sea level; a plenum chamber having a diameter greater than the third pipeline, with a bottom surface connecting the upper end of the third pipeline from the bottom up to approximately half the height of the interior space to accommodate the chlorine-and-hydrogen-containing acid water, and with the remaining space of the plenum chamber accommodating the cumulative discharge of the hydrogen; a fourth pipeline having one end connected to the top surface of the plenum and the other end connected to the drive generators to push the turbine blades; a fifth pipeline collecting hydrogen after it pushes turbine blade; a condensation chamber recovering the condensation of hydrogen from fifth pipelines; a sixth pipeline, with one end connected to an opening on sidewalls of the plenum about one-half the height and the other end connected to a storage tank; and a second booster pump, located in the sixth pipeline and pushing sodium hypochlorite in the plenum into a storage tank.

In the seawater electrolysis hydrogen recovery and power generation system as described above, the junction between the first and the second pipeline and between the second pipeline to the third pipeline may be equipped with one-way valve.

In another aspect, a platform may be positioned on the sea to accommodate water electrolysis hydrogen recovery and power generation system as described above.

The present disclosure of the electrolytic hydrogen recovery and power generation system has the lower end of the first pipeline, second pipeline, and the lower end of the third pipeline at the appropriate depth in the sea, where the water pressure is far greater than at sea level. Each fall of approximately 10 meters from the sea level, the water pressure increases by 1 atm. Therefore, if at depth of 1000 meters, the water pressure would increase to about 100 atmospheres. At this point via the first pipeline, the booster pump pushes seawater electrolysis output into the second pipeline, which is made of a soft material. Then the output is subjected to 100 atmospheric pressure, at the same time the chlorine and hydrogen inside the output also withstand 100 atmospheric pressure. When chlorine-and-hydrogen-containing seawater in the second pipeline is pumped through the third pipeline to sea level, chlorine-hydrogen complex of the seawater pressure is reduced from 100 atm to 1 atm. Generally, water temperature difference between sea-level and at 1000 m depth is about 20 25° C. The gas equation PV=nRT predicts the volume of hydrogen would increase by 2,000 times, when chlorine-hydrogen from the depth of the second pipeline through the third pipeline rises to sea level chamber. The pressure is reduced by about 100 times, and the temperature rise is about 20 times. As the hydrogen pressure in the chamber surges, and the pressure is sufficient to drive a turbine generator to produce electricity through the fourth pipeline. Thereafter the hydrogen could be guided into the condensation chamber via the fifth pipeline for recovery and storage. Linked to the chamber sidewall at approximately one-half the height, the sixth pipeline transports sodium hypochlorite, by a booster pump, into the reservoir.

The present disclosure proposes a technical solution, which not only can maintain the water electrolysis apparatus producing sodium hypochlorite function, but also can solve the issue of hydrogen spillover in the atmosphere caused by the water electrolysis apparatus that results in waste of resources and destruction of the earth's ozone layer and other issues. Detailed description of select embodiments of the present disclosure is provided below with reference to the attached drawings.

### BRIEF DESCRIPTION OF THE DRAWINGS

The accompanying drawings are included to provide a further understanding of the disclosure, and are incorporated in and constitute a part of the present disclosure. The drawings illustrate implementations of the disclosure and, together with the description, serve to explain the principles of the disclosure. It is appreciable that the drawings are not necessarily in scale as some components may be shown to be out of proportion than the size in actual implementation in order to clearly illustrate the concept of the present disclosure.

FIG. 1 is a diagram of a conventional structure of a water electrolyzer.

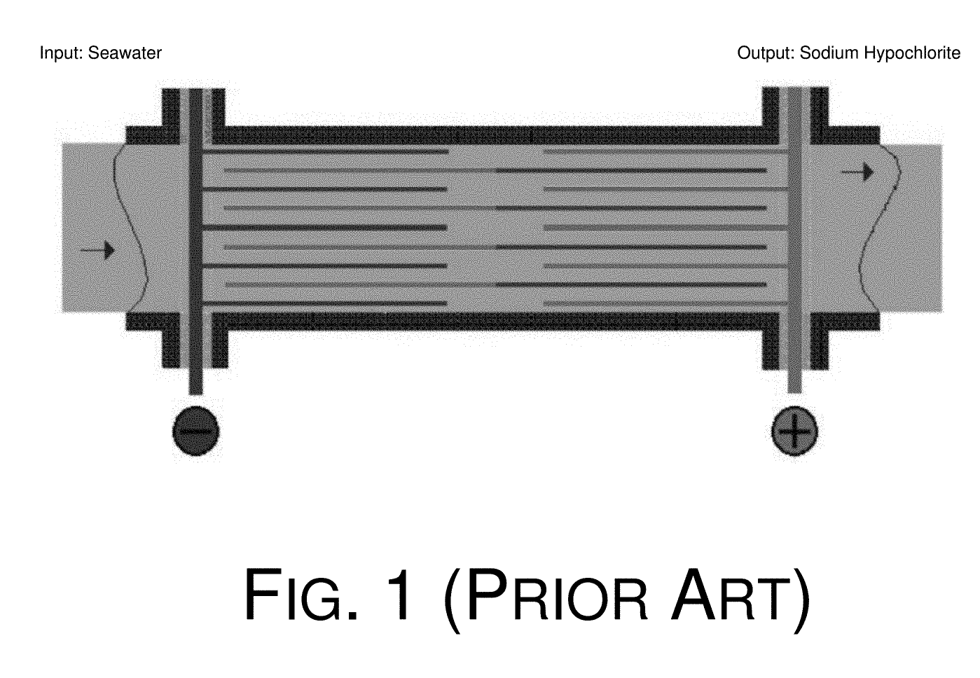

FIG. 2 is a diagram showing a relationship between a conventional seawater hypochlorite production amount and a direct-current (DC) load.

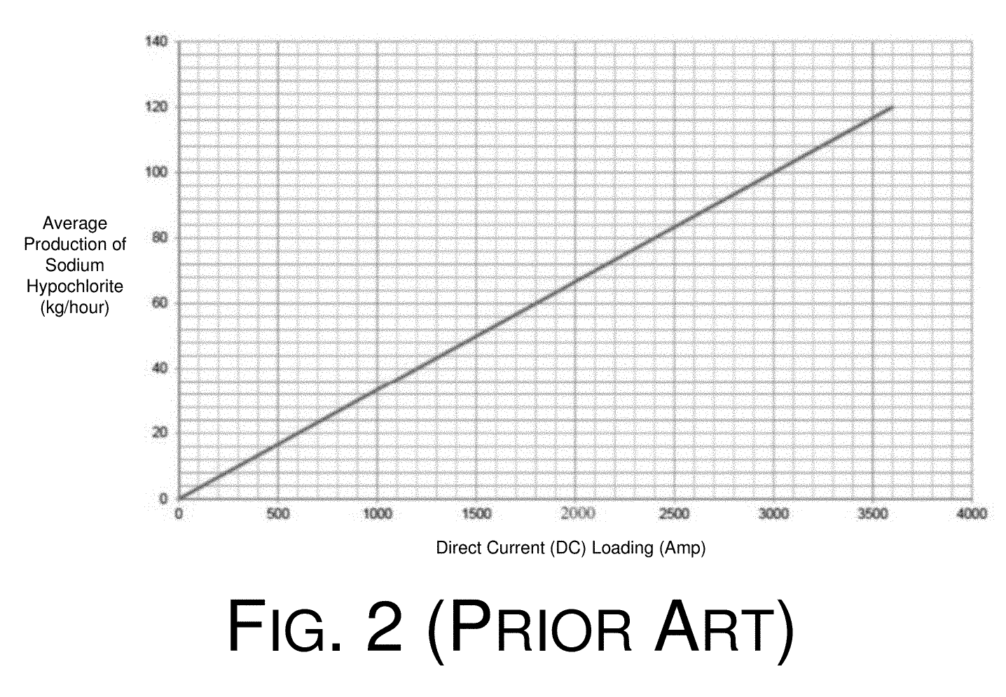

FIG. 3 is a schematic view of a seawater electrolysis hydrogen recovery and power generation system in accordance with an embodiment of the present disclosure.

FIG. 4 is a first perspective view of a seawater electrolysis hydrogen recovery and power generation system according to side aspect perspective view.

FIG. 5 is a top view of a seawater electrolysis hydrogen recovery and power generation system in accordance with an embodiment of the present disclosure.

FIG. 6 is a second perspective view of a seawater electrolysis hydrogen recovery and power generation system in accordance with an embodiment of the present disclosure.

FIG. 7 is a first enlarged perspective view of a seawater electrolysis hydrogen recovery and power generation system in accordance with an embodiment of the present disclosure after removal of working platform.

FIG. 8 is a second enlarged perspective view of a seawater electrolysis hydrogen recovery and power generation system in accordance with an embodiment of the present disclosure after removal of working platform.

### DETAILED DESCRIPTION

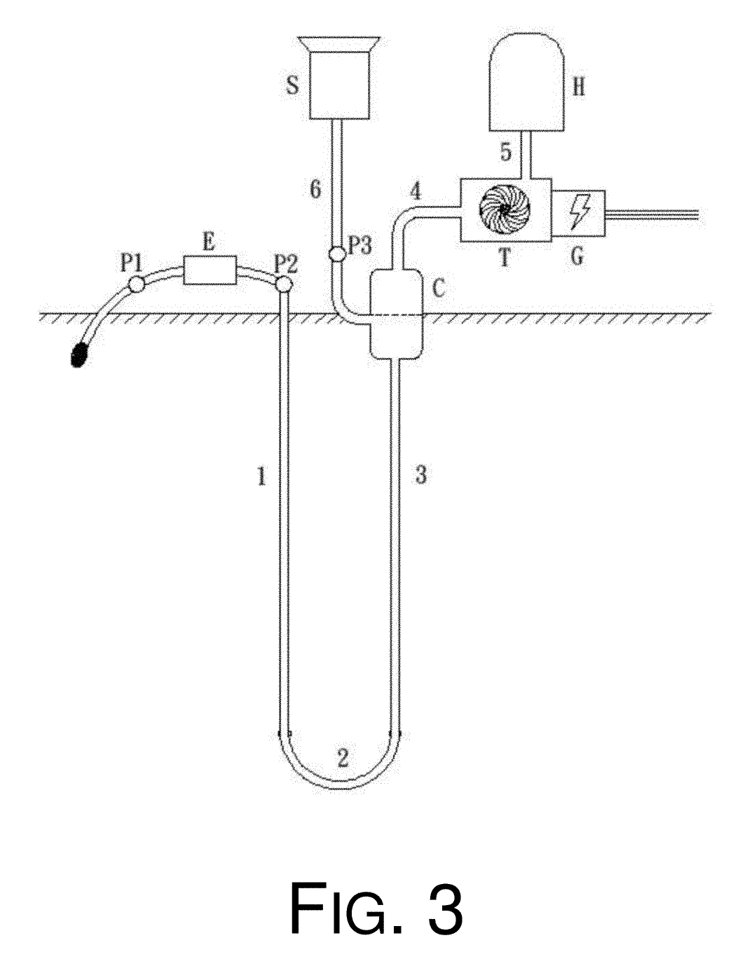

FIG. 3 illustrates a seawater electrolysis hydrogen recovery and power generation system in accordance with an embodiment of the present disclosure. A seawater electrolysis apparatus (E) is shown in FIG. 3. A front end seawater (P1) booster pump pushes seawater through decimation filter into conduit(s) between cell electrode plates where electrolytic chemical reaction takes place to result in electrolytic water containing sodium hypochlorite and hydrogen (chlorine-and-hydrogen containing seawater). The chlorine-and-hydrogen containing seawater continues to be pumped by booster pump (P2) into the deep sea through a substantially vertical pipeline (1) from the sea level. Because seawater pressure increases with depth, as the depth of the sea increases to 100 meters the water pressure increases by about 1 atm. Therefore, in the first output pipeline of seawater electrolysis apparatus (E), booster pump (P2) is added to push chlorine-and-hydrogen containing seawater into the deep sea.

A second pipeline (2), with a soft material for its wall and in a substantially horizontal suspension state, has left and right ends. The lower end of the first pipeline (1) is connected to the left end of the second pipeline (2), and the right hand side of the second pipeline (2) is connected to the lower end of a third pipeline (3). At the connection between the first pipeline (1) and the second pipeline (2), an anti-leakage ring (R1) is added, and at the connection between the second pipeline (2) and the third pipeline (3), an anti-leakage ring (R2) is added to prevent pipeline leaks inside and outside.

The third pipeline (3) from the deep is connected vertically upwards at the bottom surface of the plenum (C). The second pipeline (2) is under pressure due to the soft wall of the depths of the sea and thus may be in a depressed state until the booster pump (P2) starts to overcome pressure in pushing chlorine-and-hydrogen containing seawater into the first pipeline (1) through the second pipeline (2) and the third pipeline (3), before rising to the plenum chamber (C).

The diameter of plenum (C) may be far greater than the diameter of the third pipeline (3), and the plenum (C) may allow the sea level to reach at about half the height of plenum (C). In other words, inside the plenum chamber (C), chlorine-and-hydrogen containing seawater may account for approximately the lower half of the space, with the space of the upper half filled with chlorine and hydrogen discharged from the seawater. According to the formula PV=nRT, assuming that the second pipeline (2) is at about 1000 m below sea level at a pressure of about 100 times that at sea level, when the chlorine-and-hydrogen containing seawater rises to the plenum (C), the pressure on the hydrogen gas in the space is reduced 100 times. In accordance with general oceanographic observation data, the difference in the temperature of the seawater at the depth of 1000 m in the second pipeline (2) and the plenum (C) at sea level is between about 20 25° C. Therefore, the hydrogen volume V in the plenum chamber (C) can increase to about 2000 times the volume in the second pipeline (2).

Under the dual influence of pressure and temperature, the chlorine and hydrogen discharged to plenum (C) from the seawater would increase the amount of hydrogen in the upper half of the space. This hydrogen may go through a fourth pipeline (4) to drive a turbine (T) to cause generator (G) to generate power. Then, the hydrogen may be guided through a fifth pipeline (5) into a condensation chamber (H). As hydrogen storage and condensation can be achieved using conventional technology, it is not the focus of the present disclosure and thus is not described herein.

At about half the height of the plenum (C) around the surface of the chlorine-and-hydrogen containing seawater, a sixth pipeline (6) may be connected to the opening. By starting a pump (P3), sodium hypochlorite may be introduced into a storage tank (S). Thereafter, general application of sodium hypochlorite process may be performed.

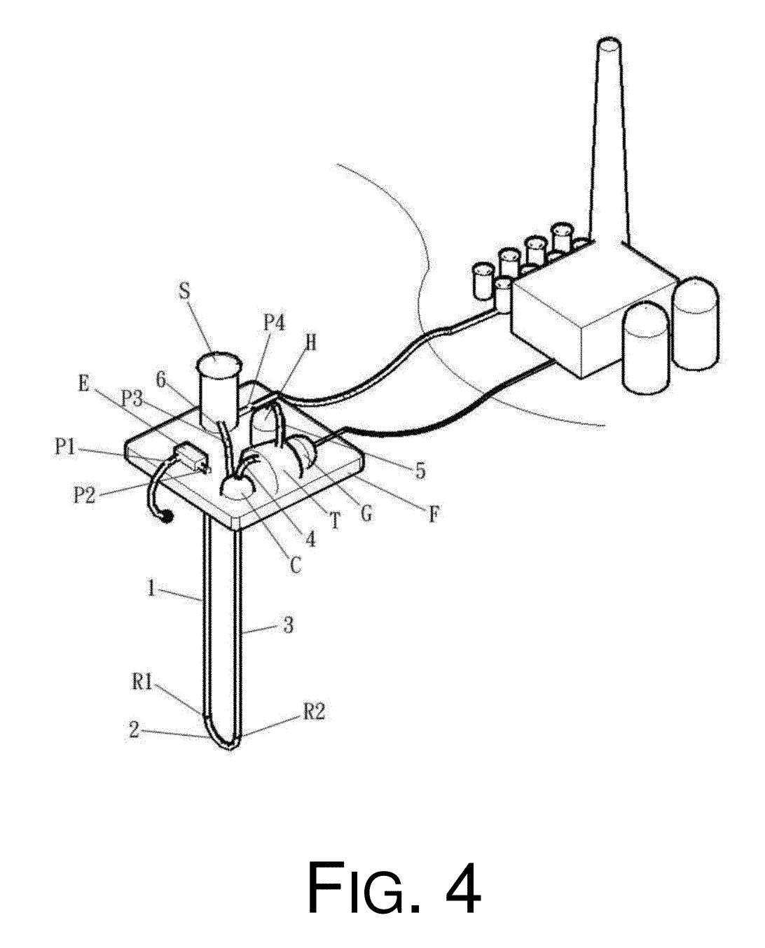

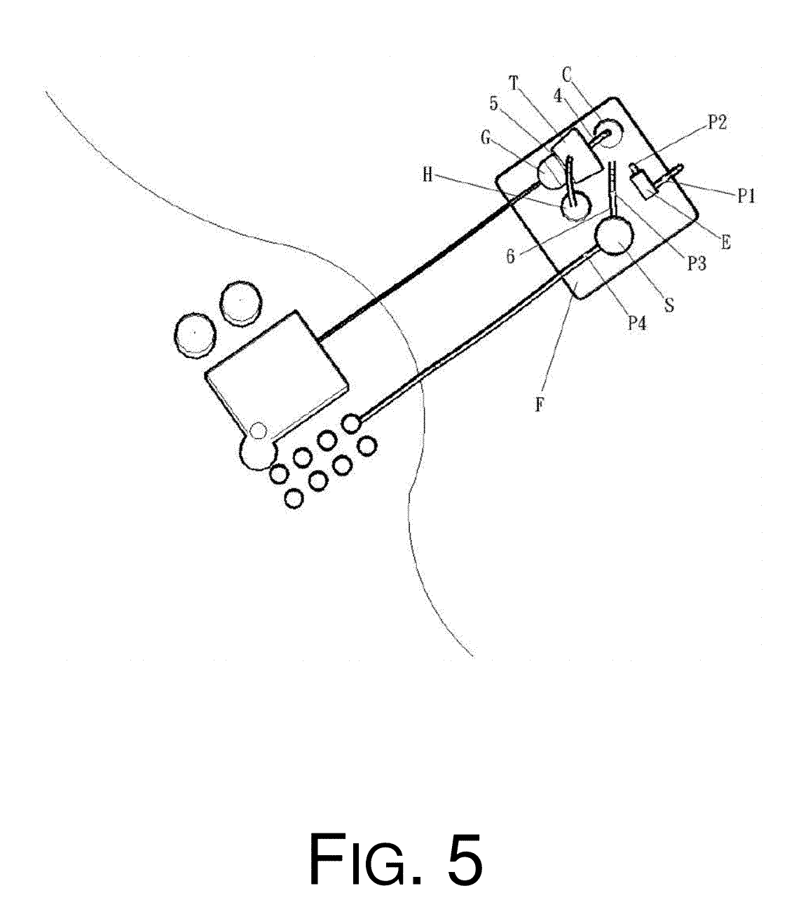

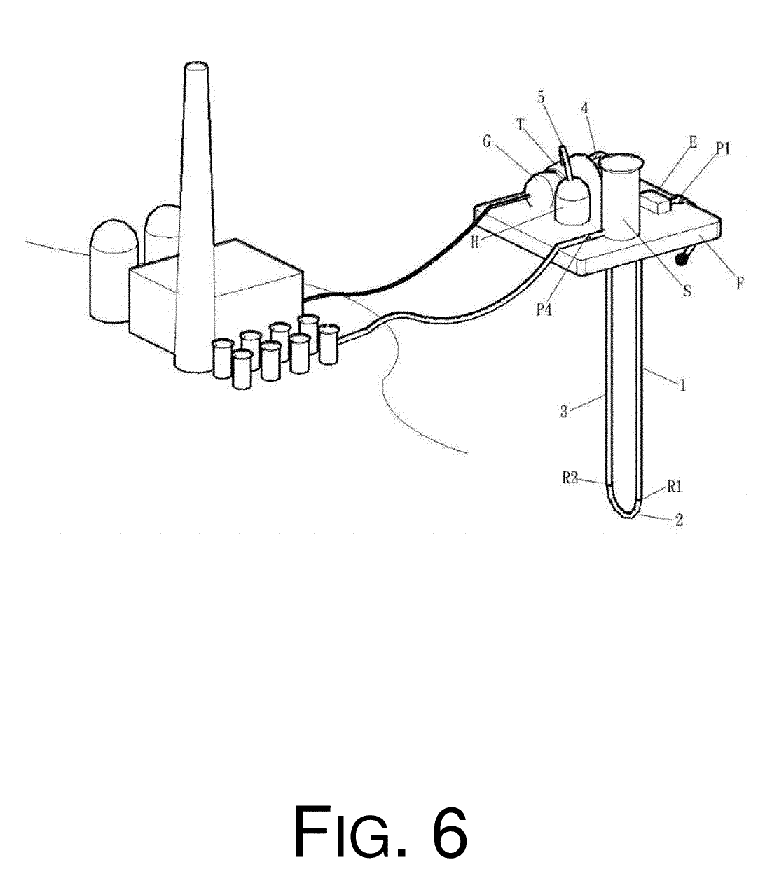

FIG. 4 is a first perspective view of a seawater electrolysis hydrogen recovery and power generation system according to side aspect perspective view. FIG. 5 shows an upper view of the seawater electrolysis hydrogen recovery and power generation system. FIG. 6 is a second perspective view of a seawater electrolysis hydrogen recovery and power generation system in accordance with an embodiment of the present disclosure. As shown in FIGS. 4-6, embodiments of the present disclosure may be implemented by first selecting suitable locations with appropriate sea depth and not far from the coastal. Using Taiwan as an example, Taiwan is surrounded by the sea with an average depth on this side of the Taiwan Strait of about 200 meters and up to 600 meters near the Penghu archipelago. In Eastern Taiwan by the Pacific Ocean, locations with seawater depth up to 1000 meters may be found about 1 km from the southeast shore for setting up a working platform (F). Working platform (F) on the sea may be built by taking advantage of existing technologies such as offshore oil drilling platforms. In addition, a large barge (barge) could also be used. Working platform (F) may have anchor structure, which may be based on a conventional technology and is not a focus of the present disclosure. For simplicity, in FIGS. 4-6 only sea platform (F) is shown to be floating on the sea.

On the working platform (F), a booster pump (P1) on the pipeline may be utilized to pump seawater into seawater electrolysis apparatus (E). After seawater electrolysis, the output of seawater electrolysis apparatus (E) is pumped by booster pump (P2) into a first pipeline (1). The first pipeline (1) may extend vertically downward to an appropriate depth. This depth preferred may be approximately 1000 meters. The lower end of the first pipeline (1) may be made of soft material, and may be connected to the left end of a second pipeline (2). The right end of the second pipeline (2) may be connected the lower end of a third pipeline (3) extending perpendicular all the way up to the sea level to the bottom surface of a plenum (C). About half of the height of plenum (C) may be immersed in the sea, with the other half thereof above the sea level. In plenum (C) lines plotted as two cylindrical shape hemispherical, one on top of the other, with a diameter greater than the diameter of the third pipeline (3). The shape of plenum (C) may be cylindrical but is not limited thereto, and may be in any other suitable shape such as, for example, spherical, football-shaped or cubic.

High-pressure hydrogen gas in the upper space of a collection chamber (C) may go through a fourth pipeline (4) to turn the turbine (T) to drive generator (G) for power generation. It can be seen in FIGS. 4-6 that the electricity generated by the electric generator (G) may be transported in parallel via a cable plant to a power grid of coastal land. A fifth pipeline (5) may be used to guide the low pressure hydrogen into a condensation chamber (H), followed by collection of hydrogen in a hydrogen storage tank. Concerning hydrogen condensation technology is a conventional technology, it is not a focus of the present disclosure and thus is not described herein.

Due to a lot of discharge of hydrogen and sodium hypochlorite seawater, in the plenum (C) at sea level, where an opening on the side wall of plenum (C) is connected to a sixth pipeline (6), sodium hypochlorite seawater may be pumped by a booster pump (P3) to push the sodium hypochlorite seawater into a sodium hypochlorite storage tank (S). Thereafter it can be used for the desired line for general plant cleaning. As shown in FIGS. 4-6, there are pipes, via a booster pump (P4), connected to a storage tank (S) of sodium hypochlorite and then connected to the sodium hypochlorite storage tank (S) along the coast of the power plant, through which the sodium hypochlorite seawater can flow.

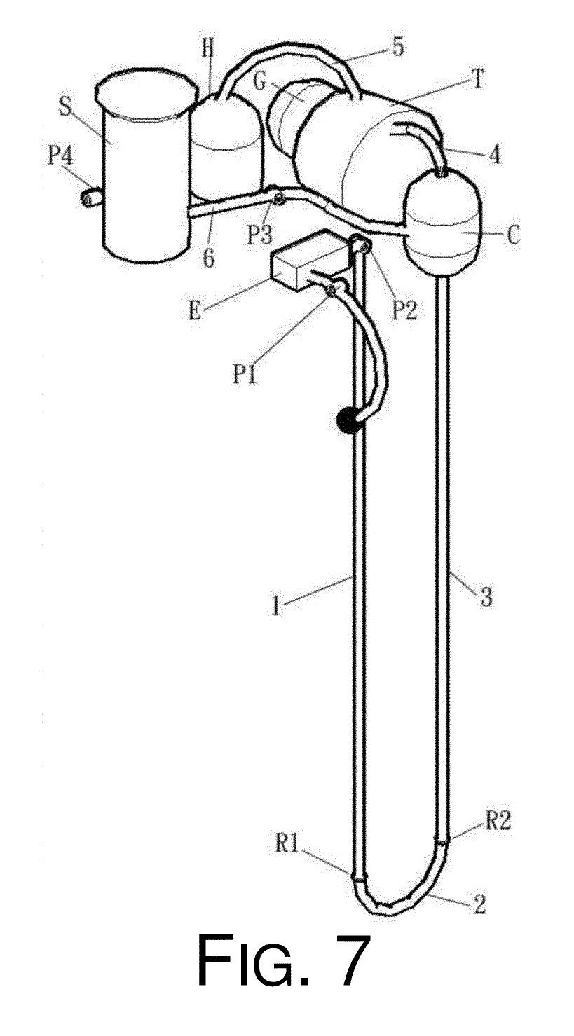

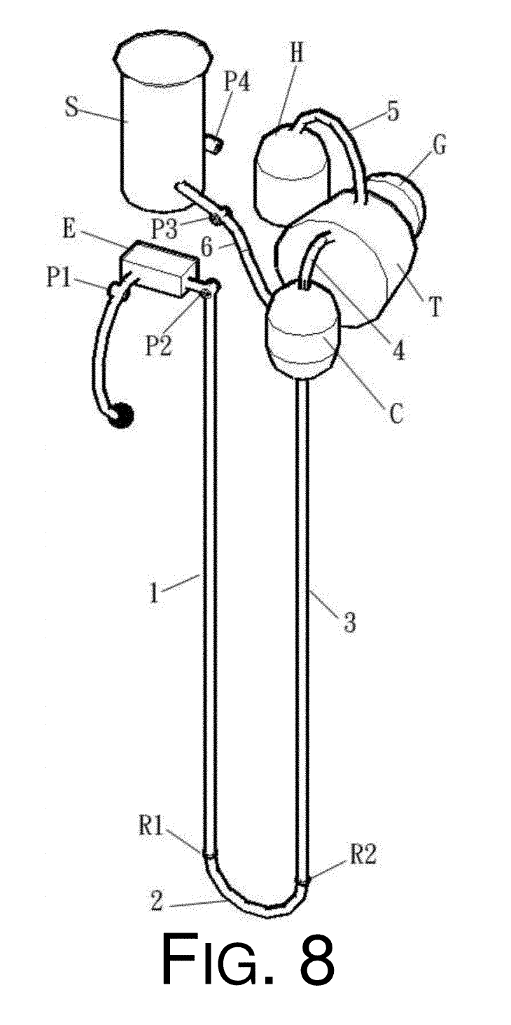

FIG. 7 is a first enlarged perspective view of a seawater electrolysis hydrogen recovery and power generation system in accordance with an embodiment of the present disclosure after removal of working platform. FIG. 8 is a second enlarged perspective view of a seawater electrolysis hydrogen recovery and power generation system in accordance with an embodiment of the present disclosure after removal of working platform. From FIGS. 7 and 8, one or ordinary skill in the art can more clearly understand the link between the piping and components of the present disclosure, as well as how they can be implemented in the industry and in various applications, as it is easy to adapt to the actual conditions by making appropriate adjustment.

As described above, the production of the sodium hypochlorite and hydrogen production may be achieved by enhancing the area of cell electrode plate or current load. As this is conventional technology, it is not a focus of the present disclosure and thus is not described herein. In implementations in which the seawater electrolysis hydrogen recovery and power generation system, which is built on a working platform, is packaged as a single unit, the amount of sodium hypochlorite and hydrogen produced may be increased by increasing the number of such a single unit. This is an application of the proposed technology of the present disclosure.

Preferably, the seawater electrolysis hydrogen recovery and power generation system in accordance with the present disclosure is powered by wind or solar cells. Such wind or solar power generation may be mounted on the working platform as necessary.

In summary, the seawater electrolysis hydrogen recovery and power generation system of the present disclosure has a number of advantages. Firstly, the seawater electrolysis hydrogen recovery device provides hydrogen to vehicle using hydrogen fuel cells. Secondly, the hydrogen collection apparatus of the seawater electrolysis prevents hydrogen from dissipating into the Earth's atmosphere to destroy the ozone layer, thus reducing global warming and improving human health. Thirdly, before the hydrogen storage, the use of high-pressure hydrogen for power generation may not only compensate the input power required, but also feed into the power grid. Fourthly, it provides the normal supply of sodium hypochlorite for clean power plant piping. Fifthly, it replaces the dehydrogenation equipment of conventional seawater electrolysis systems, thereby saving that part of the materials and energy for a power plant.

That is, with the use of seawater electrolysis hydrogen recovery and power generation system of the present disclosure, not only thermal power plants can be provided with the needed sodium hypochlorite supply, but there are also several benefits including hydrogen storage collection, power generation, environmental protection, and energy-saving. All are with great industrial utilization value. The scope of the present disclosure is not limited to power plants but all extend to industries that have use of seawater cooling circuit of facilities, such as nuclear power plants, etc. They all can benefit from the seawater electrolysis hydrogen recovery and power generation system of the present disclosure to create added value.

In view of the above, select features of the present disclosure are highlighted below.

In one aspect, a seawater electrolysis hydrogen recovery and power generation system implementable with a seawater electrolysis apparatus may include the following: a first pipeline having a first end, connectable to an output of the seawater electrolysis apparatus, and a second end; a first booster pump located in the first pipeline; a second pipeline having a first end, connected to the second end of the first pipeline, and a second end; a third pipeline having a first end, connected to the second end of the second pipeline, and a second end; a plenum chamber with a diameter greater than a diameter of the third pipeline, the plenum chamber having a bottom side connected to the second end of the third pipeline; a fourth pipeline having a first end, connected to a top side of the plenum chamber, and a second end connectable to a turbine of a power generation system such that a hydrogen gas flowing in the fourth pipeline pushes blades of the turbine to generate electricity; a fifth pipeline connectable to the turbine to collect the hydrogen gas after the hydrogen gas passes through the turbine blades; a condensation chamber configured to receive and condense the hydrogen gas from the fifth pipeline. When connected together, a portion of the first pipeline, the second pipeline, and a portion of the third pipeline may form a U-shaped structure.

In some implementations, the seawater electrolysis hydrogen recovery and power generation system may further include: a sixth pipeline having a first end, connected to the plenum chamber, and a second end connectable to a storage tank; and a second booster pump located in the sixth pipeline and between the plenum chamber and the storage tank.

In some implementations, the first end of the sixth pipeline may be connected to an opening of the plenum chamber at approximately one half of a height of the plenum chamber.

In some implementations, in operation, the opening of the plenum chamber may be below a sea level.

In some implementations, the second pipeline may have a soft wall.

In some implementations, the seawater electrolysis hydrogen recovery and power generation system may further include anti-leakage rings disposed at a connection between the first pipeline and the second pipeline and at a connection between the second pipeline and the third pipeline.

In some implementations, a portion of the first pipeline may be configured to extend downwards by a length between 10 meters and 1000 meters.

In some implementations, the seawater electrolysis hydrogen recovery and power generation system may further include: a seventh pipeline having an end connectable to the storage tank; and a third booster pump located in the seventh pipeline.

In another aspect, a sea platform may include a seawater electrolysis hydrogen recovery and power generation system and a floating device coupled to the seawater electrolysis hydrogen recovery and power generation system. The floating device may be capable of floating at a surface of the sea when disposed in the sea. The seawater electrolysis hydrogen recovery and power generation system may include: a seawater electrolysis apparatus capable of electrolyzing seawater from a sea; a first pipeline having a first end, connected to an output of the seawater electrolysis apparatus, and a second end; a first booster pump located in the first pipeline; a second pipeline having a first end, connected to the second end of the first pipeline, and a second end; a third pipeline having a first end, connected to the second end of the second pipeline, and a second end; a plenum chamber with a diameter greater than a diameter of the third pipeline, the plenum chamber having a bottom side connected to the second end of the third pipeline; a fourth pipeline having a first end, connected to a top side of the plenum chamber, and a second end connectable to a turbine of a power generation system such that a hydrogen gas flowing in the fourth pipeline pushes blades of the turbine to generate electricity; a fifth pipeline connectable to the turbine to collect the hydrogen gas after the hydrogen gas passes through the turbine blades; a condensation chamber configured to receive and condense the hydrogen gas from the fifth pipeline. When connected together, a portion of the first pipeline, the second pipeline, and a portion of the third pipeline may form a U-shaped structure.

From the foregoing, it will be appreciated that various implementations of the present disclosure have been described herein for purposes of illustration, and that various modifications may be made without departing from the scope and spirit of the present disclosure. Accordingly, the various implementations disclosed herein are not intended to be limiting, with the true scope and spirit being indicated by the following claims.

What is claimed is:

1. A seawater electrolysis hydrogen recovery and power generation system implementable with a seawater electrolysis apparatus, comprising:
a first pipeline having a first end, connectable to an output of the seawater electrolysis apparatus, and a second end;
a first booster pump located in the first pipeline;
a second pipeline having a first end, connected to the second end of the first pipeline, and a second end;
a third pipeline having a first end, connected to the second end of the second pipeline, and a second end;
a plenum chamber with a diameter greater than a diameter of the third pipeline, the plenum chamber having a bottom side connected to the second end of the third pipeline;
a fourth pipeline having a first end, connected to a top side of the plenum chamber, and a second end connectable to a turbine of a power generation system such that a hydrogen gas flowing in the fourth pipeline pushes blades of the turbine to generate electricity;
a fifth pipeline connectable to the turbine to collect the hydrogen gas after the hydrogen gas passes through the turbine blades;
a condensation chamber configured to receive and condense the hydrogen gas from the fifth pipeline,
wherein, when connected together, a portion of the first pipeline, the second pipeline, and a portion of the third pipeline form a U-shaped structure.

2. The seawater electrolysis hydrogen recovery and power generation system of claim 1, further comprising:
a sixth pipeline having a first end, connected to the plenum chamber, and a second end connectable to a storage tank; and
a second booster pump located in the sixth pipeline and between the plenum chamber and the storage tank.

3. The seawater electrolysis hydrogen recovery and power generation system of claim 2, wherein the first end of the sixth pipeline is connected to an opening of the plenum chamber at approximately one half of a height of the plenum chamber.

4. The seawater electrolysis hydrogen recovery and power generation system of claim 3, wherein, during operation, the opening of the plenum chamber is below a sea level.

5. The seawater electrolysis hydrogen recovery and power generation system of claim 1, wherein the second pipeline has a soft wall.

6. The seawater electrolysis hydrogen recovery and power generation system of claim 2, wherein the second pipeline has a soft wall.

7. The seawater electrolysis hydrogen recovery and power generation system of claim 3, wherein the second pipeline has a soft wall.

8. The seawater electrolysis hydrogen recovery and power generation system of claim 4, wherein the second pipeline has a soft wall.

9. The seawater electrolysis hydrogen recovery and power generation system of claim 1, further comprising:
anti-leakage rings disposed at a connection between the first pipeline and the second pipeline and at a connection between the second pipeline and the third pipeline.

10. The seawater electrolysis hydrogen recovery and power generation system of claim 2, further comprising:
anti-leakage rings disposed at a connection between the first pipeline and the second pipeline and at a connection between the second pipeline and the third pipeline.

11. The seawater electrolysis hydrogen recovery and power generation system of claim 3, further comprising:
anti-leakage rings disposed at a connection between the first pipeline and the second pipeline and at a connection between the second pipeline and the third pipeline.

12. The seawater electrolysis hydrogen recovery and power generation system of claim 4, further comprising:
anti-leakage rings disposed at a connection between the first pipeline and the second pipeline and at a connection between the second pipeline and the third pipeline.

13. The seawater electrolysis hydrogen recovery and power generation system of claim 1, wherein a portion of the first pipeline is configured to extend downwards by a length between 10 meters and 1000 meters.

14. The seawater electrolysis hydrogen recovery and power generation system of claim 2, wherein a portion of the first pipeline is configured to extend downwards by a length between 10 meters and 1000 meters.

15. The seawater electrolysis hydrogen recovery and power generation system of claim 3, wherein a portion of the first pipeline is configured to extend downwards by a length between 10 meters and 1000 meters.

16. The seawater electrolysis hydrogen recovery and power generation system of claim 4, wherein a portion of the first pipeline is configured to extend downwards by a length between 10 meters and 1000 meters.

17. The seawater electrolysis hydrogen recovery and power generation system of claim 2, further comprising:
a seventh pipeline having an end connectable to the storage tank; and
a third booster pump located in the seventh pipeline.

18. The seawater electrolysis hydrogen recovery and power generation system of claim 3, further comprising:
a seventh pipeline having an end connectable to the storage tank; and
a third booster pump located in the seventh pipeline.

19. The seawater electrolysis hydrogen recovery and power generation system of claim 4, further comprising:
a seventh pipeline having an end connectable to the storage tank; and
a third booster pump located in the seventh pipeline.

20. A sea platform, comprising:
a seawater electrolysis hydrogen recovery and power generation system comprising:
a seawater electrolysis apparatus capable of electrolyzing seawater from a sea;
a first pipeline having a first end, connected to an output of the seawater electrolysis apparatus, and a second end;
a first booster pump located in the first pipeline;
a second pipeline having a first end, connected to the second end of the first pipeline, and a second end;
a third pipeline having a first end, connected to the second end of the second pipeline, and a second end;
a plenum chamber with a diameter greater than a diameter of the third pipeline, the plenum chamber having a bottom side connected to the second end of the third pipeline;
a fourth pipeline having a first end, connected to a top side of the plenum chamber, and a second end connectable to a turbine of a power generation system such that a hydrogen gas flowing in the fourth pipeline pushes blades of the turbine to generate electricity;
a fifth pipeline connectable to the turbine to collect the hydrogen gas after the hydrogen gas passes through the turbine blades;
a condensation chamber configured to receive and condense the hydrogen gas from the fifth pipeline,
wherein, when connected together, a portion of the first pipeline, the second pipeline, and a portion of the third pipeline form a U-shaped structure; and
a floating device coupled to the seawater electrolysis hydrogen recovery and power generation system, the floating device capable of floating at a surface of the sea when disposed in the sea.
